(19) United States
(12) Patent Application Publication
(10) Pub. No.: US 2025/0245092 A1
(43) Pub. Date: Jul. 31, 2025

(54) SYSTEM AND METHOD FOR ROOT CAUSE CHANGE DETECTION

(71) Applicant: BigPanda, Inc., Redwood City, CA (US)

(72) Inventors: Frank A. GALLAGHER, JR., Boulder City, NV (US); Alexander PAGE, Orlando, FL (US); Nir NESS, Raanana (IL); Hadar CARMELY, Rockville, MD (US)

(73) Assignee: BigPanda, Inc., Redwood City, CA (US)

(21) Appl. No.: 18/428,863

(22) Filed: Jan. 31, 2024

(51) Int. Cl. G06F 11/07

(52) U.S. Cl. CPC G06F 11/079; G06F 11/0709; G06F 11/0793

(57) ABSTRACT

A system and method for root cause analysis in incident processing, including root cause change detection, is presented. The method includes processing a plurality of event records, including a plurality of alert records and a plurality of change records, each event record generated based on an event in a computing environment; parsing each alert record based on a predetermined data field; extracting from each predetermined data field a data value; correlating a group of alert records of the plurality of alert records based on at least an extracted data value; generating an incident data record based on the extracted data values of the correlated group of alert records; detecting a change record of the plurality of change records related to the incident data record; determining that the change record is a root cause change of the incident data record; and initiating a mitigation action based on the root cause change.

### TECHNICAL FIELD

The present disclosure relates generally to big data analytics and specifically to enhancing root cause change detection in incidents based on artificial intelligence.

### BACKGROUND

Computing environments, by virtue of their operation, generate a tremendous amount of data. Such data is generated, for example, for example by logging communication events between a first resource in a computing and a second resource in the computing environment.

For example, when a load balancer directs a request to a server, the load balancer may store a record of having sent the request to the server, and the server stores a record of receiving the request.

As another example, resources can be configured to periodically report a status, such as processor usage, memory usage, network bandwidth usage, and the like. A computing environment may be configured to store such reports.

As yet another example, various resources, monitors, agents, etc. can be configured to generate alerts based on a status of resources. For example, a server can be configured to generate an alert when processor usage exceeds some predetermined threshold.

These records, alerts, and the like, form a large body of information, which can be useful to monitor. For example, monitoring such events can lead to detecting resources which are malfunctioning, resulting in remediating the problem and increasing ‘uptime’ for a computing environment.

However, this is easier said than done. There is a large amount of information, and sifting through it is an impossible task for a human, and a hard one for a computer processor.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure. for root cause analysis in incident processing, comprising:

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, method may include processing a plurality of event records, including a plurality of alert records and a plurality of change records, each event record generated based on an event in a computing environment. Method may also include parsing each alert record based on a predetermined data field. Method may furthermore include extracting from each predetermined data field a data value. Method may in addition include correlating a group of alert records of the plurality of alert records based on at least an extracted data value. Method may moreover include generating an incident data record based on the extracted data values of the correlated group of alert records. Method may also include detecting a change record of the plurality of change records related to the incident data record. Method may furthermore include determining that the change record is a root cause change of the incident data record. Method may in addition include initiating a mitigation action based on the root cause change. Other embodiments of this aspect include corresponding computer systems, apparatus, and computer programs recorded on one or more computer storage devices, each configured to perform the actions of the methods.

Implementations may include one or more of the following features. Method may include: configuring an artificial intelligence (AI) engine to determine that the change record is the root cause change based on any one of: the extracted data values, the correlated group of alert records, and any combination thereof. Method may include: generating a first vector representation of the change record; generating a second vector representation based on: the extracted data values, the incident data record, the correlated group of alert records, and a combination thereof; and determining a distance in a vector space between the first vector and the second vector. Method may include: determining that the change record is a root cause change in response to determining that the distance is below a predetermined threshold value. Method may include: determining that the change record is a suspected root cause change in response to determining that the distance is above the predetermined threshold value. Method where the distance is further determined to be below a second predetermined threshold value. Method may include: generating a root cause analysis based on the incident record. Method may include: generating the root cause analysis further based on the determined change record. Method where generating the root cause analysis further comprises: generating a prompt for a large language model (LLM) based on: the incident record, a data schema of the computing environment, and a predetermined template, where the predetermined template includes an instruction to generate a root cause analysis; and configuring an LLM to execute the generated prompt. Implementations of the described techniques may include hardware, a method or process, or a computer tangible medium.

In one general aspect, non-transitory computer-readable medium may include one or more instructions that, when executed by one or more processors of a device, cause the device to: process a plurality of event records, including a plurality of alert records and a plurality of change records, each event record generated based on an event in a computing environment; parse each alert record based on a predetermined data field; extract from each predetermined data field a data value; correlate a group of alert records of the plurality of alert records based on at least an extracted data value; generate an incident data record based on the extracted data values of the correlated group of alert records; detect a change record of the plurality of change records related to the incident data record; determine that the change record is a root cause change of the incident data record; and initiate a mitigation action based on the root cause change. Other embodiments of this aspect include corresponding computer systems, apparatus, and computer programs recorded on one or more computer storage devices, each configured to perform the actions of the methods.

In one general aspect, system may include a processing circuitry. System may also include a memory, the memory containing instructions that, when executed by the processing circuitry, configure the system to: process a plurality of event records, including a plurality of alert records and a plurality of change records, each event record generated based on an event in a computing environment. System may in addition parse each alert record based on a predetermined data field. System may moreover extract from each predetermined data field a data value. System may also correlate a group of alert records of the plurality of alert records based on at least an extracted data value. System may furthermore generate an incident data record based on the extracted data values of the correlated group of alert records. System may in addition detect a change record of the plurality of change records related to the incident data record. System may moreover determine that the change record is a root cause change of the incident data record. System may also initiate a mitigation action based on the root cause change. Other embodiments of this aspect include corresponding computer systems, apparatus, and computer programs recorded on one or more computer storage devices, each configured to perform the actions of the methods.

Implementations may include one or more of the following features. System where the memory contains further instructions which when executed by the processing circuitry further configure the system to: configure an artificial intelligence (AI) engine to determine that the change record is the root cause change based on any one of: the extracted data values, the correlated group of alert records, and any combination thereof. System where the memory contains further instructions which when executed by the processing circuitry further configure the system to: generate a first vector representation of the change record; generate a second vector representation based on: the extracted data values, the incident data record, the correlated group of alert records, and a combination thereof; and determine a distance in a vector space between the first vector and the second vector. System where the memory contains further instructions which when executed by the processing circuitry further configure the system to: determine that the change record is a root cause change in response to determining that the distance is below a predetermined threshold value. System where the memory contains further instructions which when executed by the processing circuitry further configure the system to: determine that the change record is a suspected root cause change in response to determining that the distance is above the predetermined threshold value. System where the distance is further determined to be below a second predetermined threshold value. System where the memory contains further instructions which when executed by the processing circuitry further configure the system to: generate a root cause analysis based on the incident record. System where the memory contains further instructions which when executed by the processing circuitry further configure the system to: generate the root cause analysis further based on the determined change record. System where the memory contains further instructions that, when executed by the processing circuitry for generating the root cause analysis, further configure the system to: generate a prompt for a large language model (LLM) based on: the incident record, a data schema of the computing environment, and a predetermined template, where the predetermined template includes an instruction to generate a root cause analysis; and configure an LLM to execute the generated prompt. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example schematic illustration of a network diagram including an incident server, implemented in accordance with an embodiment.

FIG. 2 is an example schematic illustration of a data flow for incident record generation, implemented in accordance with an embodiment.

FIG. 3 is an example flowchart of a method for generating an incident data record based on a plurality of event records, implemented in accordance with an embodiment.

FIG. 4 is an example flowchart of incident summary generation, implemented in accordance with an embodiment.

FIG. 5 is an example schematic diagram of an incident server according to an embodiment.

FIG. 6 is an example graphical user interface of an incident summary generated by an incident server, utilized to describe an embodiment.

FIG. 7 is an example graphical user interface for providing input on an incident report generation, utilized to describe an embodiment.

FIG. 8 is an example flowchart of a method for detecting a change in a computing environment leading to an incident, implemented in accordance with an embodiment.

FIG. 9 is an example graphical user interface illustrating a plurality of alerts.

FIG. 10 is an example graphical user interface illustrating a plurality of suspect changes, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

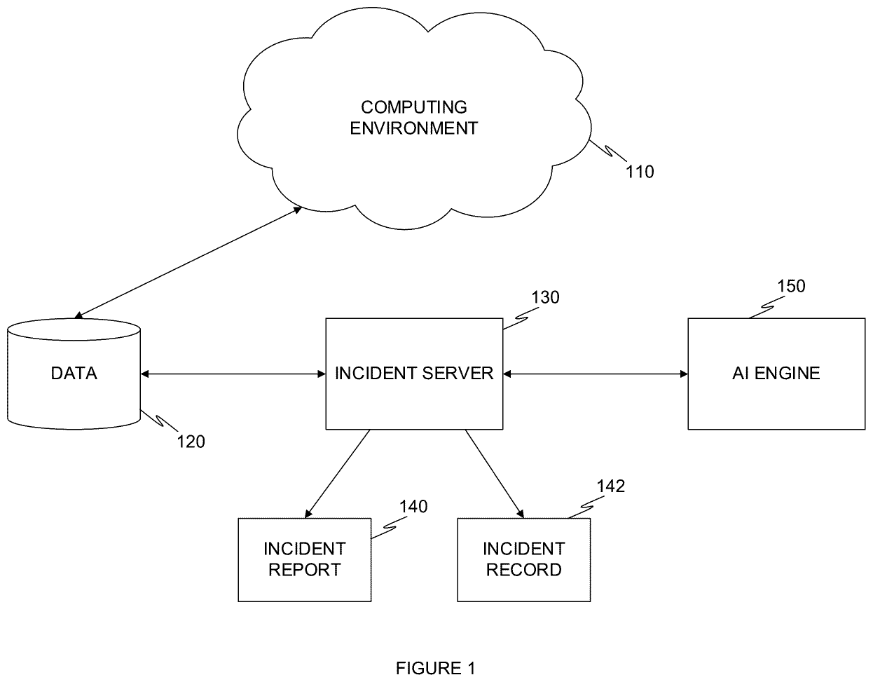

FIG. 1 is an example schematic illustration of a network diagram including an incident server, implemented in accordance with an embodiment. In an embodiment, a computing environment 110 includes a plurality of entities. In some embodiments, the computing environment 110 is a cloud computing environment, an on-prem computing environment, a networked computing environment, a hybrid computing environment, a combination thereof, and the like.

For example, according to an embodiment, a computing environment 110 includes a virtual private cloud (VPC), a virtual network (VNet), a virtual private network (VPN), a subnet, a combination thereof, and the like. In certain embodiments, a cloud computing environment is implemented on a cloud computing infrastructure, such as Amazon® Web Services (AWS), Google® Cloud Platform, Microsoft® Azure, and the like.

According to an embodiment, an entity is, for example, a resource, a principal, various combinations thereof, and the like. In an embodiment, a resource is a virtual instance, such as a virtual machine, a software container, a serverless function, a combination thereof, and the like. In certain embodiments, a resource exposes a hardware resource, a virtual resource, and the like, of the computing environment, for use by a principal.

In some embodiments, a principal is an entity which is authorized to initiate actions in the computing environment 110. For example, according to an embodiment, a principal is a user account, a service account, a user group, a user role, a local account, an administrator account, various combinations thereof, and the like.

According to an embodiment, the computing environment 110 is configured to generate records of actions, events, alerts, and the like, initiated, performed, etc., in the computing environment 110. For example, in an embodiment, a first resource (e.g., a load balancer) is configured to communicate with a second resource (e.g., a web server). In some embodiments, each resource is configured to write a record for every action performed, such as sending a communication from the first resource to the second resource, receiving a communication by the second resource from the first resource, initiating a user account, updating privilege of a user account, writing to a bucket, accessing a log, etc.

In certain embodiments, an event record indicates a change in the computing environment 110. For example, in an embodiment, a change includes blocking network traffic on a specific port, provisioning a web application firewall (WAF), provisioning a proxy server, changing permission of a resource, changing permission of a principal, updating a software application version, updating an operating system version, changing a software library, changing a software binary, a combination thereof, and the like.

In an embodiment, the computing environment 110, a resource, a principal, a combination thereof, and the like, are configured to write events, records, etc. to a data store 120. In certain embodiments, the data store 120 is implemented as a bucket which is configured to store thereon events received from, for example, a serverless function deployed in the computing environment 110. In an embodiment, the data store 120 is a managed service (e.g., SaaS), such as AWS CloudTrail®.

In some embodiments, the data store 120 includes a network log, a cloud log, an identity and access management (IAM) log, a combination thereof, and the like. In some embodiments, a log includes a plurality of data records. For example, a data record includes data values which pertain to a specific event, action, and the like, performed in the computing environment, to the computing environment, etc. In some embodiments, a data record includes a plurality of data fields, each data field storing a value.

According to an embodiment, a data record is parsed to extract a data field value therefrom. In an embodiment, the data record is parsed to extracted values only from predetermined data fields. In certain embodiments, a predetermined field identifier is determined prior to extracting data values from a data record. For example, in an embodiment, a data field identifier is defined by a tag, e.g., ‘machine_id’. In such an example embodiment, data records are parsed to identify the predetermined tag (e.g., the ‘machine_id’) tag, and a value in the data record which corresponds to the tag is extracted therefrom.

In certain embodiments, an incident server 130 is configured to access a data store 120 and extract data values from data records stored thereon, or otherwise accessible thereto. In an embodiment, an incident server 130 is configured to generate an incident record 142. In some embodiments, the incident record 142 includes data values extracted from a plurality of data records.

In some embodiments, the incident server 130 is configured to generate an incident record 142 based on a predetermined heuristic, rule, policy, combination thereof, and the like. For example, in an embodiment, the incident server 130 is configured to correlate a plurality of events into an incident record 142. In some embodiments, a plurality of incidents are correlated based on a tag (e.g., a data field), a plurality of tags, a time window, a time frame, a combination thereof, and the like.

In an embodiment, the incident server 130 is further configured to generate an incident report 140. In certain embodiments, the incident report 140 is generated based on the incident record 142, the plurality of events which are correlated to the incident record 142, a combination thereof, and the like.

According to some embodiments, the incident server 130 is configured to generate a input for an artificial intelligence (AI) engine 150. In an embodiment, the AI engine includes a large language model (LLM). In some embodiments, the LLM is OpenAI® GPT, Google® PaLM, Meta® LLaMA, and the like.

In certain embodiments, the incident server 130 is configured to generate the input for the AI engine 150 as a prompt. In some embodiments, incident server is configured to generate the prompt based on a predefined template.

For example, in an embodiment, the incident server 130 is configured to generate a prompt based on a plurality of correlated events and provide the generated prompt to an LLM of an AI engine 150. In some embodiments, the prompt, when processed by the LLM, configures the AI engine 150 to generate an output. In an embodiment, the generated output is utilized in generating an incident report 140.

In some embodiments, an incident report 140 includes an incident summary, a root cause analysis, a root cause analysis reasoning, a combination thereof, and the like. In an embodiment, the incident report 140 is stored as a data file, data record, and the like. In some embodiments, the incident report 140 is further generated based on a template, a plurality of correlated events, an output of an LLM, a combination thereof, and the like.

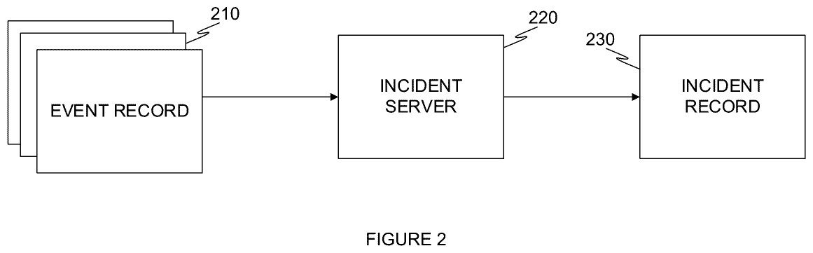

FIG. 2 is an example schematic illustration of a data flow for incident record generation, implemented in accordance with an embodiment. According to some embodiments, a plurality of event records 210 are accessed. In an embodiment, the plurality of event records 210 are records of events stored in a data log. In some embodiments, an event is stored as a single line of text, hypertext, markup language, a combination thereof, and the like, for example in a log.

In an embodiment, an event record includes a plurality of tags, data fields, and the like, which are utilized in identifying data values. For example, in an embodiment, a ‘destination’ tag is followed by a value for an IP address (e.g., ‘128.0.0.1’). In some embodiments, a plurality of data fields are associated with a single tag. For example, according to an embodiment, a first event has a ‘dest’ data field, a second event has a ‘destination’ data field, etc., each of which is associated with a ‘destination’ tag.

In some embodiments, an incident server 220 is configured to receive the plurality of event records 210. In certain embodiments, the incident server 220 is configured to access, receive, extract, a combination thereof, and the like, an event record from a data store, a network log, a cloud log, and the like.

In certain embodiments, the incident server 220 is configured to generate an incident record 230 from the plurality of event records 210. In some embodiments, the incident server 220 is configured to correlate events of the plurality of events records 210. In an embodiment, a first event record and a second event record are correlated based on a data field, tag, and the like, such as any one of: a workload name, a timestamp, a range of time, an event type, a support ticket type, a unique identifier, a host name, an event record source, an event description, a combination thereof, and the like.

In certain embodiments, the incident server 220 is configured to correlate events based on a plurality of data fields (tags, and the like). In an embodiment, the incident server 220 is configured to correlate events based on values of data fields.

In an embodiment, the incident server 220 is configured to generate an incident record 230 based on a plurality of correlated events. In some embodiments, the correlated events are a subset of the plurality of event records 210.

According to an embodiment, an incident record 230 is a data record which includes data values extracted from the correlated event records. In some embodiments, generating an incident record 230 from the correlated event records is advantageous, as storing an incident record 230 requires less storage space than storing all of the correlated event records. This is due, for example, to extracting only values only of predetermined data fields. Thus, the incident record 230 stores therein less data than the correlated event records together.

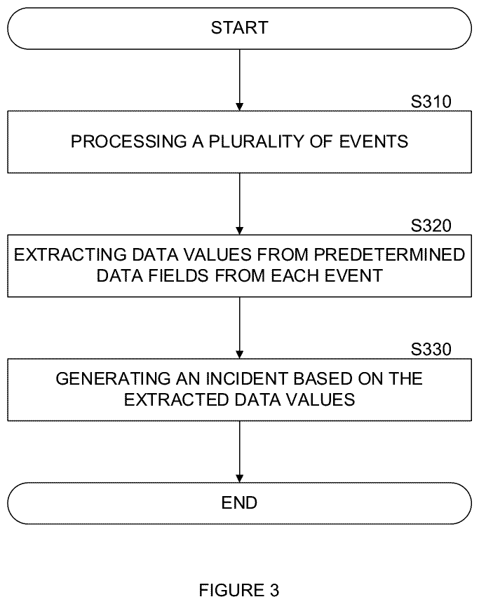

FIG. 3 is an example flowchart of a method for generating an incident data record based on a plurality of event records, implemented in accordance with an embodiment. In some embodiments, generating an incident data record (also referred to as ‘incident’ or ‘incident record’) is performed by an incident server, such as described in more detail herein. In some embodiments, the incident server is configured to generate an incident record by utilizing an AI engine, for example having an LLM.

In an embodiment, the AI engine, the incident server, and the like, are configured to provide context data to the LLM. In some embodiments, context data includes a data schema, metadata, and the like. In an embodiment, the incident server is configured to generate a prompt using retrieval augmented generation (RAG). In certain embodiments, generating a prompt using RAG includes generating a prompt based on context data. In an embodiment, context data is retrieved from a data store.

At S310, a plurality of event records are processed. In an embodiment, a plurality of event records (also referred to as ‘events’) are received. In certain embodiments, the events are received as a stream of events. In some embodiments, an event log, a cloud log, a network log, a bucket, a cloud-based storage, combinations thereof, and the like, are accessed to retrieve therefrom event records.

In an embodiment, accessing a store of event records includes receiving an access credentials, such as a token, a username, a password, a combination thereof, and the like, where the credentials provide temporary access, permanent access, etc. In an embodiment, event records are received (or otherwise accessed) continuously, periodically, dynamically, adaptively, and the like.

In an embodiment, dynamic access includes accessing event records at a pace which changes over time. In some embodiments, adaptive access includes changing access times based on, for example, a number of records. As an example, in an embodiment, at a first rate of access, 100 event records are fetched. The rate of access is decreased, until a second rate of access, at which a number of events fetched exceeds a threshold.

In an embodiment, an event record is an alert, a record of communication between resources (e.g., machines, virtual instances, and the like in a computing environment), a record of communication between principals, a record of creating a principal, a failure of a component of the computing environment, various combinations thereof, and the like.

At S320, data values are extracted from an event record. In an embodiment, an event record is parsed based on predetermined data fields. In an embodiment, an event record is parsed based on a predetermined tag. According to some embodiments, a tag includes a plurality of identifiers of data fields, each of which pertains to a same type, context, and the like, of data. For example, a tag ‘resource’ is associated with data fields ‘id’, ‘name’, ‘machine’, and the like, according to an embodiment.

In certain embodiments, a data field is an indicator, for example extracted from an event record. In some embodiments, the event record is parsed to detect keywords, key phrases, and the like. For example, where an event record includes ‘ec2-instance_id-region’, the parsed terms of ‘ec2’ indicate that the computing environment is Amazon® Web Services (AWS), and that ‘instance_id’ is an identifier of a virtual instance deployed in a region ‘region’ of AWS.

In some embodiments, events are correlated. In certain embodiments, an incident server is configured to correlate a plurality of events. In an embodiment, correlated events correspond to an incident. For example, according to an embodiment, an incident is a loss of service, which corresponds to a first event indicating a failure of a load balancer, a second event indicating a first server is not responding, a third event indicating a second server is not responding, etc. In an embodiment, events are correlated based on a timestamp, a data field, an indicator, metadata, data values, and the like, of event records.

At S330, an incident record is generated. In an embodiment, an incident server is configured to generate an incident record based on data extracted from a plurality of events. In some embodiments, it is advantageous to maintain an incident record, as the incident record contains therein only data that is predetermined to be relevant to an incident. Thus, the amount of data is reduced, which allows to store multiple incidents for a longer time (e.g., using the same amount of storage), allows searching through incident records faster (i.e., searching a smaller data set is faster than searching through a larger data set), etc.

In some embodiments, the incident record is further generated based on a result from an AI engine. In certain embodiments, a plurality of incidents are provided to an AI engine in order to determine which events are correlated to a single incident. In some embodiments, an event is related to a plurality of incidents.

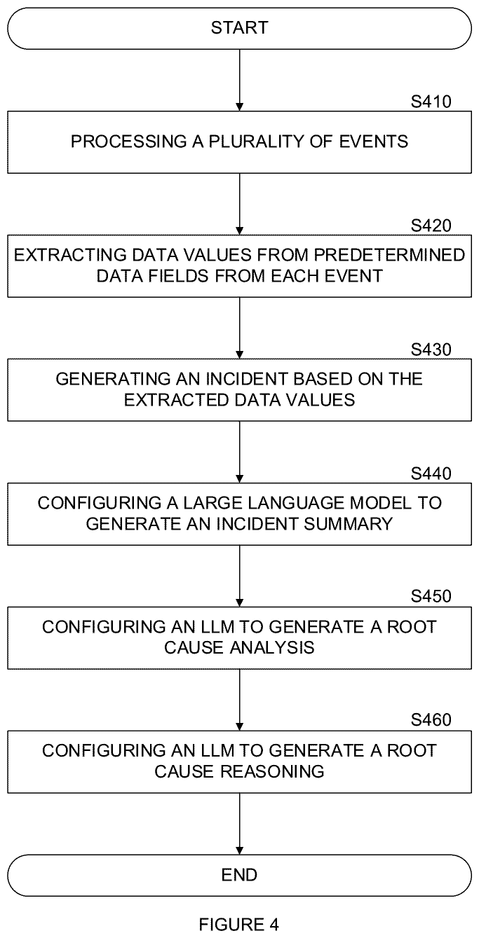

FIG. 4 is an example flowchart of incident summary generation, implemented in accordance with an embodiment. According to an embodiment, correlating a plurality of event records into a single incident is useful, however outputting to a user a plurality of data records (e.g., the correlated event records) can be a lot, especially if an incident includes thousands, tens of thousands, etc. alerts, events, and the like.

It is therefore advantageous in an embodiment, to provide an incident summary, including a root cause analysis, and a root cause reasoning to explain in terms that can be easily understood by a human operator, what the incident indicates, what is a possible root cause, and why this is suspected as the root cause.

At S410, a plurality of events is processed. In an embodiment, a plurality of event records (also referred to as ‘events’) are received. In certain embodiments, the events are received as a stream of events. In some embodiments, an event log, a cloud log, a network log, a bucket, a cloud-based storage, combinations thereof, and the like, are accessed to retrieve therefrom event records.

In an embodiment, accessing a store of event records includes receiving an access credentials, such as a token, a username, a password, a combination thereof, and the like, where the credentials provide temporary access, permanent access, etc. In an embodiment, event records are received (or otherwise accessed) continuously, periodically, dynamically, adaptively, and the like.

In an embodiment, dynamic access includes accessing event records at a pace which changes over time. In some embodiments, adaptive access includes changing access times based on, for example, a number of records. As an example, in an embodiment, at a first rate of access, 100 event records are fetched. The rate of access is decreased, until a second rate of access, at which a number of events fetched exceeds a threshold.

In an embodiment, an event record is an alert, a record of communication between resources (e.g., machines, virtual instances, and the like in a computing environment), a record of communication between principals, a record of creating a principal, a failure of a component of the computing environment, various combinations thereof, and the like.

At S420, data values are extracted from an event record. In an embodiment, an event record is parsed based on predetermined data fields. In an embodiment, an event record is parsed based on a predetermined tag. According to some embodiments, a tag includes a plurality of identifiers of data fields, each of which pertains to a same type, context, and the like, of data. For example, a tag ‘resource’ is associated with data fields ‘id’, ‘name’, ‘machine’, and the like, according to an embodiment.

In certain embodiments, a data field is an indicator, for example extracted from an event record. In some embodiments, the event record is parsed to detect keywords, key phrases, and the like. For example, where an event record includes ‘ec2-instance_id-region’, the parsed terms of ‘ec2’ indicate that the computing environment is Amazon® Web Services (AWS), and that ‘instance_id’ is an identifier of a virtual instance deployed in a region ‘region’ of AWS.

In some embodiments, events are correlated. In certain embodiments, an incident server is configured to correlate a plurality of events. In an embodiment, correlated events correspond to an incident. For example, according to an embodiment, an incident is a loss of service, which corresponds to a first event indicating a failure of a load balancer, a second event indicating a first server is not responding, a third event indicating a second server is not responding, etc. In an embodiment, events are correlated based on a timestamp, a data field, an indicator, metadata, data values, and the like, of event records.

At S430, an incident record is generated. In an embodiment, an incident server is configured to generate an incident record based on data extracted from a plurality of events. In some embodiments, it is advantageous to maintain an incident record, as the incident record contains therein only data that is predetermined to be relevant to an incident. Thus, the amount of data is reduced, which allows to store multiple incidents for a longer time (e.g., using the same amount of storage), allows searching through incident records faster (i.e., searching a smaller data set is faster than searching through a larger data set), etc.

In some embodiments, the incident record is further generated based on a result from an AI engine. In certain embodiments, a plurality of incidents are provided to an AI engine in order to determine which events are correlated to a single incident. In some embodiments, an event is related to a plurality of incidents.

At S440, an incident summary is generated. In an embodiment, generating an incident summary includes generating a prompt for a large language model (LLM). In some embodiments, an incident server is configured to generate a prompt for an LLM, for example based on a predefined template. In some embodiments, the template is modified based on context data, metadata, and the like, associated with events correlated to the incident.

For example, in an embodiment, an incident server is configured to modify a prompt template based on context data, metadata, and the like, of a data source from which the correlated events are received. In an embodiment, the incident server is further configured to generate a prompt for an LLM based on the modified prompt, wherein the generated prompt includes the incident record data (i.e., data which was extracted from the correlated event records).

In an embodiment, the prompt, when processed by a machine, virtual instance, and the like, utilizing an LLM, configures the machine to generate an output which includes an incident summary which is presented in natural language. In an embodiment, the output is a textual output.

LLMs are models which have a fixed-size input, also known as a context length. For example, an LLM includes a 16 k (i.e., 16,000) context length of tokens, 32 k, 64 k, 128 k, and the like. In some embodiments, a publicly available LLM which is provided as a Software as a Service (SaaS) utilizes a single model that has different context lengths provided at different costs (e.g., 32 k is cheaper than 64 k, and more expensive than 16 k).

It is therefore advantageous, according to an embodiment, to provide the LLM an incident record having only values of predetermined data fields, rather than provide all the correlated event records as an input.

In an embodiment, a first advantage is utilizing the shortest possible context length, which leads to a reduction of compute usage (also translating to a reduction in cost). In an embodiment, a second advantage is effectively compressing incident data to only the relevant data, thus the longest context length of the model is not exceeded (or rarely exceeded), even for incidents which include a large number of correlated event records.

According to an embodiment, utilizing an incident record in place of utilizing the plurality of correlated event records as an input for the LLM reduces the number of incidents for which an incident summary cannot be produced because of a large number of events.

In certain embodiments, where a generated incident record includes data from a plurality of correlated events resulting in data which exceeds the context length of the LLM, a plurality of secondary incident records are generated based on the correlated events. For example, in an embodiment, an incident server is configured to generate a first secondary incident record based on a first group of correlated event records, and a second secondary incident record base on a second group of correlated event records. In some embodiments, a third group of correlated event records overlaps the first group of correlated event records and the second group of correlated event records.

At S450, an incident root cause analysis is generated. In an embodiment, generating a root cause analysis includes generating a prompt for a large language model (LLM). In some embodiments, an incident server is configured to generate a prompt for an LLM, for example based on a predefined template. In some embodiments, the template is modified based on context data, metadata, and the like, associated with events correlated to the incident.

In an embodiment, the template includes an input for the LLM which further configures the LLM to generate an incident summary. In certain embodiments, the template further includes an input which configures the LLM to generate the root cause analysis based on the incident record and the incident summary.

For example, in an embodiment, an incident server is configured to modify a prompt template based on context data, metadata, and the like, of a data source from which the correlated events are received. In an embodiment, the incident server is further configured to generate a prompt for an LLM based on the modified prompt, wherein the generated prompt includes the incident record data (i.e., data which was extracted from the correlated event records).

In an embodiment, the prompt, when processed by a machine, virtual instance, and the like, utilizing an LLM, configures the machine to generate an output which includes a root cause analysis which is presented in natural language. In an embodiment, the output is a textual output.

LLMs are models which have a fixed-size input, also known as a context length. For example, an LLM includes a 16 k (i.e., 16,000) context length of tokens, 32 k, 64 k, 128 k, and the like. In some embodiments, a publicly available LLM which is provided as a Software as a Service (Saas) utilizes a single model that has different context lengths provided at different costs (e.g., 32 k is cheaper than 64 k, and more expensive than 16 k).

It is therefore advantageous, according to an embodiment, to provide the LLM an incident record having only values of predetermined data fields, rather than provide all the correlated event records as an input.

In an embodiment, a first advantage is utilizing the shortest possible context length, which leads to a reduction of compute usage (also translating to a reduction in cost). In an embodiment, a second advantage is effectively compressing incident data to only the relevant data, thus the longest context length of the model is not exceeded (or rarely exceeded), even for incidents which include a large number of correlated event records.

According to an embodiment, utilizing an incident record in place of utilizing the plurality of correlated event records as an input for the LLM reduces the number of incidents for which a root cause analysis cannot be produced because of a large number of events.

In certain embodiments, where a generated incident record includes data from a plurality of correlated events resulting in data which exceeds the context length of the LLM, a plurality of secondary incident records are generated based on the correlated events. For example, in an embodiment, an incident server is configured to generate a first secondary incident record based on a first group of correlated event records, and a second secondary incident record base on a second group of correlated event records. In some embodiments, a third group of correlated event records overlaps the first group of correlated event records and the second group of correlated event records.

In some embodiments, a first LLM is provided with a prompt to generate an incident summary and a second LLM is provided with a prompt to generate a root cause analysis. In some embodiments, the first LLM includes a first context length, and the second LLM includes a second context length. In an embodiment, the first context length is longer than the second context length.

According to an embodiment, the first LLM is provided with a prompt generated at least based on correlated event records and context data, and the second LLM is provided with a prompt generated based at least on an output of the first LLM.

At S460, a root cause reasoning is generated. In an embodiment, generating a root cause reasoning includes generating a prompt for a large language model (LLM). In some embodiments, an incident server is configured to generate a prompt for an LLM, for example based on a predefined template. In some embodiments, the template is modified based on context data, metadata, and the like, associated with events correlated to the incident.

In an embodiment, the template includes an input for the LLM which further configures the LLM to generate a root cause reasoning. In certain embodiments, the template further includes an input which configures the LLM to generate the root cause reasoning based on any of: the incident record, the incident summary, the root cause analysis, and a combination thereof.

For example, in an embodiment, an incident server is configured to modify a prompt template based on context data, metadata, and the like, of a data source from which the correlated events are received. In an embodiment, the incident server is further configured to generate a prompt for an LLM based on the modified prompt, wherein the generated prompt includes the incident record data (i.e., data which was extracted from the correlated event records).

In an embodiment, the prompt, when processed by a machine, virtual instance, and the like, utilizing an LLM, configures the machine to generate an output which includes a root cause reasoning which is presented in natural language. In an embodiment, the output is a textual output.

LLMs are models which have a fixed-size input, also known as a context length. For example, an LLM includes a 16 k (i.e., 16,000) context length of tokens, 32 k, 64 k, 128 k, and the like. In some embodiments, a publicly available LLM which is provided as a Software as a Service (Saas) utilizes a single model that has different context lengths provided at different costs (e.g., 32 k is cheaper than 64 k, and more expensive than 16 k).

It is therefore advantageous, according to an embodiment, to provide the LLM an incident record having only values of predetermined data fields, rather than provide all the correlated event records as an input.

In an embodiment, a first advantage is utilizing the shortest possible context length, which leads to a reduction of compute usage (also translating to a reduction in cost). In an embodiment, a second advantage is effectively compressing incident data to only the relevant data, thus the longest context length of the model is not exceeded (or rarely exceeded), even for incidents which include a large number of correlated event records.

According to an embodiment, utilizing an incident record in place of utilizing the plurality of correlated event records as an input for the LLM reduces the number of incidents for which a root cause analysis cannot be produced because of a large number of events.

In certain embodiments, where a generated incident record includes data from a plurality of correlated events resulting in data which exceeds the context length of the LLM, a plurality of secondary incident records are generated based on the correlated events. For example, in an embodiment, an incident server is configured to generate a first secondary incident record based on a first group of correlated event records, and a second secondary incident record base on a second group of correlated event records. In some embodiments, a third group of correlated event records overlaps the first group of correlated event records and the second group of correlated event records.

In some embodiments, a first LLM is provided with a prompt to generate an incident summary, a second LLM is provided with a prompt to generate a root cause analysis, and a third LLM is provided with a prompt to generate a root cause reasoning. In some embodiments, the first LLM includes a first context length, the second LLM includes a second context length, and the third LLM includes a second context length. In an embodiment, the first context length is longer than the second context length, and the second context length is equal to, or greater than, the third context length.

According to an embodiment, the first LLM is provided with a prompt generated at least based on correlated event records and context data, the second LLM is provided with a prompt generated based at least on an output of the first LLM, and the third LLM is provided with a prompt generated based at least on an output of the first LLM and an output of the second LLM. In an embodiment, the second LLM and the third LLM are the same LLM. In some embodiments, the first LLM, the second LLM, and the third LLM are all the same model.

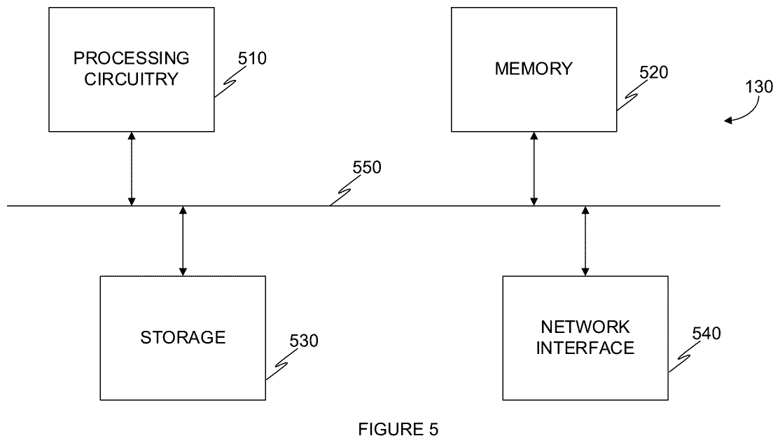

FIG. 5 is an example schematic diagram of an incident server 130 according to an embodiment. The incident server 130 includes, according to an embodiment, a processing circuitry 510 coupled to a memory 520, a storage 530, and a network interface 540. In an embodiment, the components of the incident server 130 are communicatively connected via a bus 550.

In certain embodiments, the processing circuitry 510 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 520 is a volatile memory (e.g., random access memory, etc.), a non-volatile memory (e.g., read only memory, flash memory, etc.), a combination thereof, and the like. In some embodiments, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein is stored in the storage 530, in the memory 520, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 510, cause the processing circuitry 510 to perform the various processes described herein, in accordance with an embodiment.

In some embodiments, the storage 530 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 540 is configured to provide the incident server 130 with communication with, for example, the computing environment 110, the data store 120, the AI engine 150, and the like, according to an embodiment.

It should be understood that the embodiments described herein are not limited to the specific architecture illustrated in FIG. 5, and other architectures may be equally used without departing from the scope of the disclosed embodiments.

Furthermore, in certain embodiments the data store 120, the AI engine 150, and the like may be implemented with the architecture illustrated in FIG. 5. In other embodiments, other architectures may be equally used without departing from the scope of the disclosed embodiments.

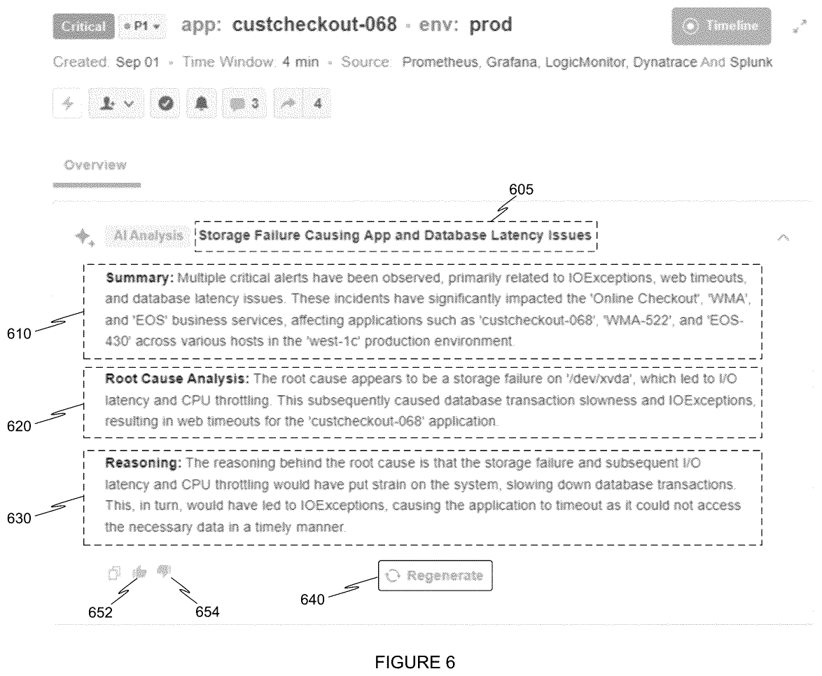

FIG. 6 is an example graphical user interface of an incident summary generated by an incident server, utilized to describe an embodiment. In an embodiment, an incident server, such as the incident server 130 of FIG. 1 above, is configured to generate a graphical user interface (GUI), including various graphical and textual elements.

In an embodiment, a GUI includes an incident report generated based on an incident record. For example, in an embodiment, the incident report includes a title 605, a summary 610, a root cause analysis 620, and a root cause reasoning 630. In some embodiments, the text of the summary 610 is generated utilizing the techniques discussed in more detail above, such as in S440 of FIG. 4 above.

In certain embodiments, the text of the root cause analysis 620 is generated utilizing the techniques discussed in more detail above, such as in S450, and the text of the root cause reasoning is generated utilizing for example the techniques discussed in more detail above at S450 of FIG. 4.

In an embodiment, the GUI further includes a regenerate button 640. In some embodiments, the regenerate button 640 is an interactive graphical element, allowing to receive a user input through the graphical user interface. In certain embodiments, receiving an input from the regenerate button 640 (e.g., a mouse click on the graphical portion thereof) configures an incident server to regenerate the incident report, the incident summary, the root cause analysis, the root cause reasoning, a combination thereof, and the like.

In some embodiments, the GUI further includes an approval input 652, a disapproval input 654, a combination thereof, and the like. For example, in an embodiment, the approval input 652, the disapproval input 654, and the like, are binary toggles, having an ‘on’ and ‘off’ state.

In an embodiment, an input from a binary toggle is utilized in training an LLM which generated the incident summary, the root cause analysis, the root cause reasoning, a combination thereof, and the like. In some embodiments, the input is utilized in a reinforced learning mechanism for an AI engine.

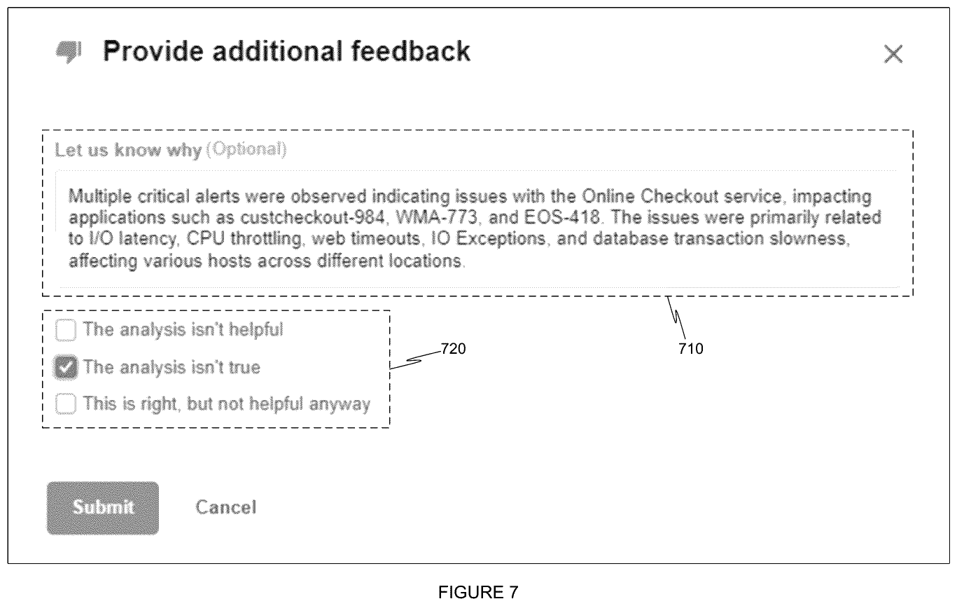

In certain embodiments, providing an input through the disapproval input 654 configures the incident server to generate a second GUI, the second GUI allowing a user to provide inputs, such as illustrated in FIG. 7 below.

FIG. 7 is an example graphical user interface for providing input on an incident report generation, utilized to describe an embodiment. In an embodiment, the GUI is generated based on an input received from a user, for example through a primary graphical user interface, such as shown in FIG. 6 above.

In some embodiments, the GUI includes a textual input 710, for providing a text input from a user of the graphical user interface. In certain embodiments, the GUI includes a plurality of various input options. In an embodiment, an input option is optional, or mandatory. In an embodiment, the textual input 710 is limited in characters, unlimited in characters, etc.

In certain embodiments, the GUI further includes a checkbox input 720, a toggle input, and the like. For example, in an embodiment, the checkbox input 720 includes a predetermined phrase (e.g., ‘The analysis isn't helpful’) and a corresponding checkbox, wherein a user interacting with the checkbox (e.g., by clicking with a pointer device) configures the checkbox to a first state (e.g., checked) or a second state (e.g., unchecked), such that each input reverses the current state of the checkbox input 720.

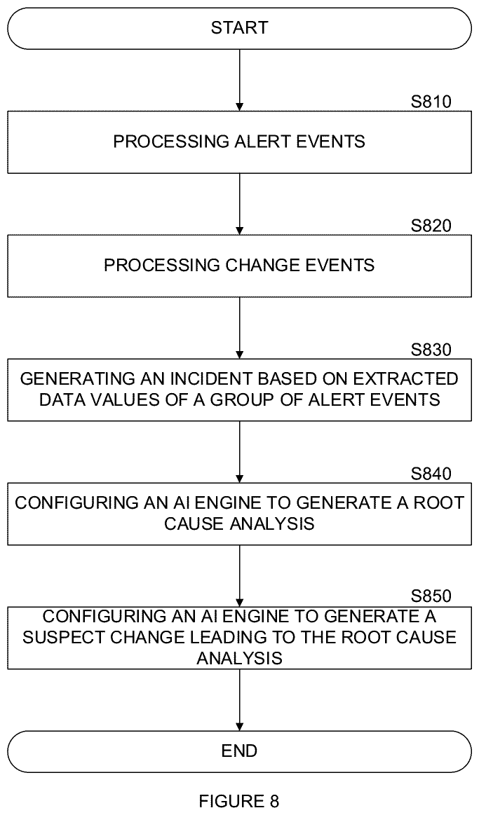

FIG. 8 is an example flowchart of a method for detecting a change in a computing environment leading to an incident, implemented in accordance with an embodiment.

At S810, a plurality of alert events are processed. In an embodiment, a plurality of alerts are received, fetched, accessed, and the like, for example by an incident server. In some embodiments, an alert is generated by a monitoring system, such as Prometheus™, Grafana™, LogicMonitor™, Dynatrace™, Splunk™, and the like.

In an embodiment, an alert includes various data fields, such as an identifier of a resource, an identifier of a principal, an identifier of an event, an event type, a timestamp, a combination thereof, and the like.

In certain embodiments, alerts are received periodically, continuously, a combination thereof, and the like. For example, in an embodiment, Prometheus alerts are received periodically and Grafana alerts are received continuously, respective of the same computing environment.

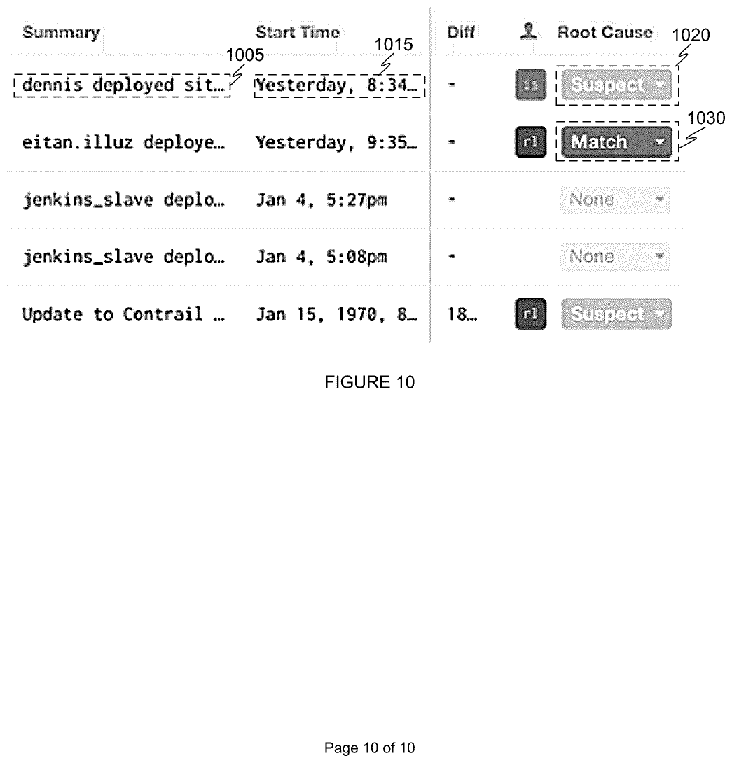

At S820, a plurality of change event are processed. In an embodiment, a change event is an event record which indicates a change in the computing environment. In some embodiments, a change event is indicated as being performed by a principal. An example of this is discussed in more detail with respect to FIG. 10 below.

According to an embodiment, a change includes blocking network traffic on a specific port, provisioning a web application firewall (WAF), provisioning a proxy server, changing permission of a resource, changing permission of a principal, updating a software application version, updating an operating system version, changing a software library, changing a software binary, a combination thereof, and the like.

At S830, an incident record is generated. In certain embodiments, the incident record is generated based on the alert events. In some embodiments, the incident record is generated based on data values extracted from the alerts. In an embodiment, an alert record is parsed based on predetermined data fields. In an embodiment, an alert record is parsed based on a predetermined tag. According to some embodiments, a tag includes a plurality of identifiers of data fields, each of which pertains to a same type, context, and the like, of data. For example, a tag ‘resource’ is associated with data fields ‘id’, ‘name’, ‘machine’, and the like, according to an embodiment.

In certain embodiments, a data field is an indicator, for example extracted from an alert record. In some embodiments, the alert record is parsed to detect keywords, key phrases, and the like. For example, where an event record includes ‘ec2-instance_id-region’, the parsed terms of ‘ec2’ indicate that the computing environment is Amazon® Web Services (AWS), and that ‘instance_id’ is an identifier of a virtual instance deployed in a region ‘region’ of AWS.

In some embodiments, alerts are correlated. In certain embodiments, an incident server is configured to correlate a plurality of alerts. In an embodiment, correlated alerts correspond to an incident. For example, according to an embodiment, an incident is a loss of service, which corresponds to a first event indicating a failure of a load balancer, a second event indicating a first server is not responding, a third event indicating a second server is not responding, etc. In an embodiment, alerts are correlated based on a timestamp, a data field, an indicator, metadata, data values, and the like, of alert records.

In an embodiment, an incident server is configured to generate an incident record based on data extracted from a plurality of alerts. In some embodiments, it is advantageous to maintain an incident record, as the incident record contains therein only data that is predetermined to be relevant to an incident. Thus, the amount of data is reduced, which allows to store multiple incidents for a longer time (e.g., using the same amount of storage), allows searching through incident records faster (i.e., searching a smaller data set is faster than searching through a larger data set), etc.

In some embodiments, the incident record is further generated based on a result from an AI engine. In certain embodiments, a plurality of alerts are provided to an AI engine in order to determine which alerts are correlated to a single incident. In some embodiments, an alert is related to a plurality of incidents.

At S840, an incident root cause analysis is generated. In an embodiment, generating a root cause analysis includes generating a prompt for a large language model (LLM). In some embodiments, an incident server is configured to generate a prompt for an LLM, for example based on a predefined template. In some embodiments, the template is modified based on context data, metadata, and the like, associated with alerts correlated to the incident.

In an embodiment, the template includes an input for the LLM which further configures the LLM to generate an incident summary. In certain embodiments, the template further includes an input which configures the LLM to generate the root cause analysis based on the incident record and the incident summary.

For example, in an embodiment, an incident server is configured to modify a prompt template based on context data, metadata, and the like, of a data source (e.g., Prometheus) from which the correlated alerts are received. In an embodiment, the incident server is further configured to generate a prompt for an LLM based on the modified prompt, wherein the generated prompt includes the incident record data (i.e., data which was extracted from the correlated alert records).

In an embodiment, the prompt, when processed by a machine, virtual instance, and the like, utilizing an LLM, configures the machine to generate an output which includes a root cause analysis which is presented in natural language. In an embodiment, the output is a textual output.

LLMs are models which have a fixed-size input, also known as a context length. For example, an LLM includes a 16 k (i.e., 16,000) context length of tokens, 32 k, 64 k, 128 k, and the like. In some embodiments, a publicly available LLM which is provided as a Software as a Service (Saas) utilizes a single model that has different context lengths provided at different costs (e.g., 32 k is cheaper than 64 k, and more expensive than 16 k).

It is therefore advantageous, according to an embodiment, to provide the LLM an incident record having only values of predetermined data fields, rather than provide all the correlated alert records as an input.

In an embodiment, a first advantage is utilizing the shortest possible context length, which leads to a reduction of compute usage (also translating to a reduction in cost). According to an embodiment, a second advantage is effectively compressing incident data to only the relevant data, thus the longest context length of the model is not exceeded (or rarely exceeded), even for incidents which include a large number of correlated alert records.

According to an embodiment, utilizing an incident record in place of utilizing the plurality of correlated alert records as an input for the LLM reduces the number of incidents for which a root cause analysis cannot be produced because of a large number of events.

In certain embodiments, where a generated incident record includes data from a plurality of correlated alerts resulting in data which exceeds the context length of the LLM, a plurality of secondary incident records are generated based on the correlated alerts.

For example, in an embodiment, an incident server is configured to generate a first secondary incident record based on a first group of correlated alert records, and a second secondary incident record base on a second group of correlated alert records. In some embodiments, a third group of correlated alert records overlaps the first group of correlated alert records and the second group of correlated alert records.

In some embodiments, a first LLM is provided with a prompt to generate an incident summary and a second LLM is provided with a prompt to generate a root cause analysis. In some embodiments, the first LLM includes a first context length, and the second LLM includes a second context length. In an embodiment, the first context length is longer than the second context length.

According to an embodiment, the first LLM is provided with a prompt generated at least based on correlated alert records and context data, and the second LLM is provided with a prompt generated based at least on an output of the first LLM.

At S850, a suspect change is detected. In an embodiment, a list of suspected changes is detected, each associated with a probability. According to an embodiment, a suspect change is a change event record which indicates a change in the computing environment, which can be a cause of the incident.

According to some embodiments, a suspect change is detected based on detecting a plurality of change events corresponding to the incident record. In an embodiment, the plurality of change events includes a change occurring within a predefined time window prior to the incident, a change occurring during the incident, a combination thereof, and the like.

In certain embodiments, a change is determined to be a suspect change by detecting a textual similarity between the change record and: the incident record, an event record, a combination thereof, and the like. In an embodiment, a vector space modeling technique is utilized to determine a textual similarity. For example, in some embodiments, the vector space modeling technique is Bag-of-Words.

In some embodiments, a textual similarity is determined where the distance between a vector representing the change record and a vector representing an event record, an incident record, and the like, is below a predetermined threshold. In certain embodiments, a plurality of thresholds are utilized, such that below a first predetermined threshold a change is categorized as confirmed, between the first predetermined threshold and a second predetermined threshold the change is categorized as suspect, and above the second predetermined threshold the change is categorized as unlikely.

In an embodiment, the suspect change is selected from the plurality of processed change event records. In certain embodiments, an incident server is configured to generate a prompt for an LLM, for example based on a predefined template, which when executed configure the LLM to output a suspect change of the change events.

In some embodiments, the prompt includes the incident summary and the plurality of change events. In certain embodiments, each change event is preprocessed to generate a modified change event, wherein a modified change event includes only a portion of data values of a change event (i.e., a modified change event is a data record generated based on a change event record such that the modified change event has reduced data stored therein).

In an embodiment, an incident server is configured to generated a modified change event by extracting values of predetermined data fields of a change event record. In some embodiments, it is advantageous to provide an LLM with a modified change event record as a input, as this reduces the amount of data the LLM is required to process.

In some embodiments, the incident server is further configured to generate a prompt which when executed by the LLM is configured to generate a probability that a suspect change is a root cause for the incident. In certain embodiments, the probability is a quantitative value, a qualitative value, a combination thereof, and the like. For example, a quantitative value is an integer (e.g., a value between ‘1’ and ‘5’), and a qualitative value is ‘low’ to ‘high’, according to an embodiment.

In some embodiments, the incident server is further configured to generate a remediation action, mitigation action, and the like, based on the root cause change. For example, in an embodiment, a remediation action includes rolling back a change, revoking a permission, uninstalling a software update, installing a second software update, a combination thereof, and the like.

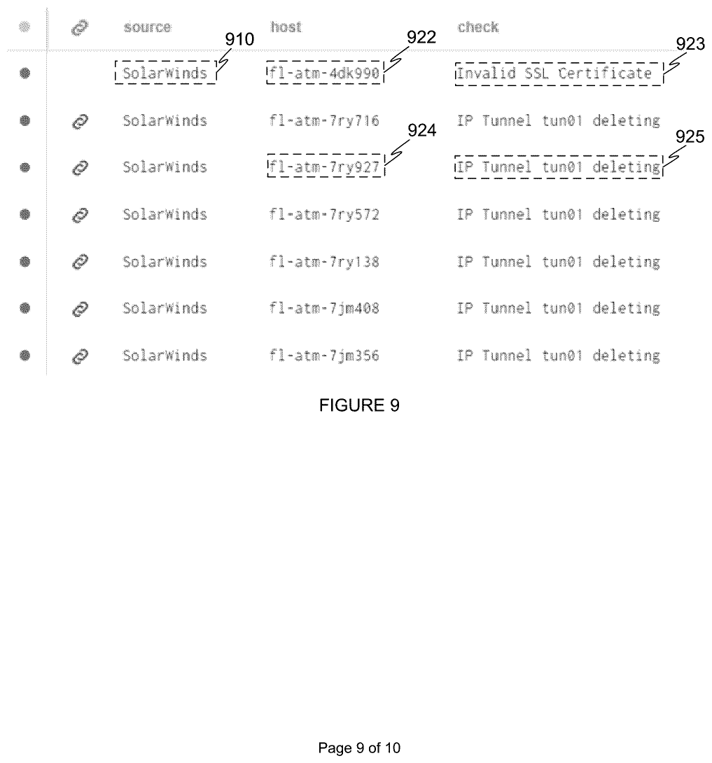

FIG. 9 is an example graphical user interface illustrating a plurality of alerts. In an embodiment, an alert includes a source 910, such as SolarWinds®. In some embodiments, the alert includes an identifier of a resource, such as host 922. In certain embodiments, the source 910 is a source for a plurality of alerts, for example with respect to the host 922 and a second host 924.

In some embodiments, an alert includes a detail, such as first alert 923 with respect to the host 922, and second alert 925 with respect to the second host 924, both of which originated from the same monitoring system (e.g., source 910).

FIG. 10 is an example graphical user interface illustrating a plurality of suspect changes, implemented in accordance with an embodiment. In an embodiment, a change event includes a summary 1005, a start time 1015, and a root cause status 1020. For example, in an embodiment, the root cause status 1020 of the first change event is ‘suspect’, indicating that the change event is suspected as having caused the incident.

In some embodiments, a root cause status 1030 of a second change event is ‘match’, indicating that the change event is the root cause of the incident. According to an embodiment, an incident server is configured to assign a root cause a status based on, for example, a predetermined threshold for a determined probability. For example, where a probability that a change event is a root cause exceeds 90%, the event is categorized as ‘match’. As another example, where a probability that a change event is a root cause exceeds 50% and is lower than 80%, the event is categorized as ‘suspect’.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for root cause analysis in incident processing, comprising:
processing a plurality of event records, including a plurality of alert records and a plurality of change records, each event record generated based on an event in a computing environment;
parsing each alert record based on a predetermined data field;
extracting from each predetermined data field a data value;
correlating a group of alert records of the plurality of alert records based on at least an extracted data value;
generating an incident data record based on the extracted data values of the correlated group of alert records;
generating a first vector representation of the change record in a vector database;
generating a second vector representation in the vector database based on: the extracted data values, the incident data record, the correlated group of alert records, and a combination thereof;
determining a distance in a vector space between the first vector and the second vector;
determining that the change record of the plurality of change records is related to the incident data record based on the determined distance;
determining that the change record is a root cause change of the incident data record; and
initiating a mitigation action in the computing environment based on the root cause change.

2. The method of claim 1, further comprising:
configuring an artificial intelligence (AI) engine to determine that the change record is the root cause change based on any one of: the extracted data values, the correlated group of alert records, and any combination thereof.

3. (canceled)

4. The method of claim 1, further comprising:
determining that the change record is a root cause change in response to determining that the distance is below a predetermined threshold value.

5. The method of claim 4, further comprising:
determining that the change record is a suspected root cause change in response to determining that the distance is above the predetermined threshold value.

6. The method of claim 5, wherein the distance is further determined to be below a second predetermined threshold value.

7. The method of claim 1, further comprising:
generating a root cause analysis based on the incident record.

8. The method of claim 7, further comprising:
generating the root cause analysis further based on the determined change record.

9. The method of claim 7, wherein generating the root cause analysis further comprises:
generating a prompt for a large language model (LLM) based on: the incident record, a data schema of the computing environment, and a predetermined template, wherein the predetermined template includes an instruction to generate a root cause analysis; and
configuring an LLM to execute the generated prompt.

10. A non-transitory computer-readable medium storing a set of instructions for root cause analysis in incident processing, the set of instructions comprising:
one or more instructions that, when executed by one or more processors of a device, cause the device to:
process a plurality of event records, including a plurality of alert records and a plurality of change records, each event record generated based on an event in a computing environment;
parse each alert record based on a predetermined data field;
extract from each predetermined data field a data value;
correlate a group of alert records of the plurality of alert records based on at least an extracted data value;
generate an incident data record based on the extracted data values of the correlated group of alert records;
generate a first vector representation of the change record in a vector database;
generate a second vector representation in the vector database based on: the extracted data values, the incident data record, the correlated group of alert records, and a combination thereof;
determine a distance in a vector space between the first vector and the second vector;
determining that the change record of the plurality of change records is related to the incident data record based on the determined distance;
determine that the change record is a root cause change of the incident data record; and
initiate a mitigation action in the computing environment based on the root cause change.

11. A system for root cause analysis in incident processing comprising:
a processing circuitry;
a memory, the memory containing instructions that, when executed by the processing circuitry, configure the system to:
process a plurality of event records, including a plurality of alert records and a plurality of change records, each event record generated based on an event in a computing environment;
parse each alert record based on a predetermined data field;
extract from each predetermined data field a data value;
correlate a group of alert records of the plurality of alert records based on at least an extracted data value;
generate an incident data record based on the extracted data values of the correlated group of alert records;
generate a first vector representation of the change record in a vector database;
generate a second vector representation in the vector database based on: the extracted data values, the incident data record, the correlated group of alert records, and a combination thereof;
determine a distance in a vector space between the first vector and the second vector;
determine that the change record of the plurality of change records is related to the incident data record based on the determined distance;
determine that the change record is a root cause change of the incident data record; and
initiate a mitigation action in the computing environment based on the root cause change.

12. The system of claim 11, wherein the memory contains further instructions which when executed by the processing circuitry further configure the system to:
configure an artificial intelligence (AI) engine to determine that the change record is the root cause change based on any one of:
the extracted data values, the correlated group of alert records, and any combination thereof.

13. (canceled)

14. The system of claim 11, wherein the memory contains further instructions which when executed by the processing circuitry further configure the system to:
determine that the change record is a root cause change in response to determining that the distance is below a predetermined threshold value.

15. The system of claim 14, wherein the memory contains further instructions which when executed by the processing circuitry further configure the system to:
determine that the change record is a suspected root cause change in response to determining that the distance is above the predetermined threshold value.

16. The system of claim 15, wherein the distance is further determined to be below a second predetermined threshold value.

17. The system of claim 11, wherein the memory contains further instructions which when executed by the processing circuitry further configure the system to:
generate a root cause analysis based on the incident record.

18. The system of claim 17, wherein the memory contains further instructions which when executed by the processing circuitry further configure the system to:
generate the root cause analysis further based on the determined change record.

19. The system of claim 17, wherein the memory contains further instructions that, when executed by the processing circuitry for generating the root cause analysis, further configure the system to:
generate a prompt for a large language model (LLM) based on: the incident record, a data schema of the computing environment, and a predetermined template, wherein the predetermined template includes an instruction to generate a root cause analysis; and
configure an LLM to execute the generated prompt.
